(19) United States
(12) Patent Application Publication
(10) Pub. No.: US 2024/0111104 A1
(43) Pub. Date: Apr. 4, 2024

(54) FIBER OPTIC ADAPTER ASSEMBLIES INCLUDING A CONVERSION HOUSING AND A RELEASE HOUSING

(71) Applicant: CORNING RESEARCH & DEVELOPMENT CORPORATION, CORNING, NY (US)

(72) Inventors: Guy Barthes, Pontchateau (FR); Thierry Luc Alain Dannoux, Avon (FR); Michel Teva Menguy, Austin, TX (US); Felice Scotta, Savigny le Temple (FR)

(21) Appl. No.: 18/540,333

(22) Filed: Dec. 14, 2023

Related U.S. Application Data
(63) Continuation of application No. 17/527,311, filed on Nov. 16, 2021, now Pat. No. 11,880,076.
(60) Provisional application No. 63/119,622, filed on Nov. 30, 2020.

(51) Int. Cl. G02B 6/38

(52) U.S. Cl. CPC G02B 6/389; G02B 6/3825; G02B 6/3831; G02B 6/3843

(57) ABSTRACT

A fiber optic connector assembly includes a connector housing defining locking portion defined, an adapter assembly selectively coupled to the connector housing, the adapter assembly including a conversion housing extending around the connector housing and defining a conversion retention member that is positionable between an engaged position, in which the conversion retention member restricts movement of the connector housing with respect to the adapter assembly in an axial direction, and a disengaged position, in which the connector housing is movable with respect to the adapter assembly in the axial direction, and a release housing positioned between the conversion housing and the connector housing, the release housing defining a release front end positionable at least partially within the conversion housing, and a release face selectively engageable with the conversion retention member and configured to move the conversion retention member from the engaged position to the disengaged position.

### CROSS-REFERENCE TO RELATED APPLICATIONS

This application is a continuation of U.S. application Ser. No. 17/527,311 filed Nov. 16, 2021, which claims the benefit of priority under 35 U.S.C. § 119 to U.S. Provisional Application No. 63/119,622 filed Nov. 30, 2020. The content of each aforementioned priority application is relied upon and incorporated herein by reference in its entirety.

### BACKGROUND

The present disclosure generally relates to fiber optic adapter assemblies for connecting optical fibers, and more particularly to fiber optic adapter assemblies including a conversion housing and a release housing.

Optical fibers are used in an increasing number and variety of applications, such as a wide variety of telecommunications and data transmission applications. As a result, fiber optic networks include an ever increasing number of terminated optical fibers and fiber optic cables that can be conveniently and reliable mated with corresponding optical receptacles in the network. These terminated optical fibers and fiber optic cables are available in a variety of connectorized formats including, for example, hardened OptiTap® and OptiTip® connectors, field-installable UniCam® connectors, preconnectorized single or multi-fiber cable assemblies with SC, FC, or LC connectors, etc., all of which are available from Corning Incorporated, with similar products available from other manufacturers, as is well documented in the patent literature.

The optical receptacles with which the aforementioned terminated fibers and cables are coupled are commonly provided at optical network units (ONUs), network interface devices (NIDs), and other types of network devices or enclosures, and often require hardware that is sufficiently robust to be employed in a variety of environments under a variety of installation conditions. These conditions may be attributable to the environment in which the connectors are employed, or the habits of the technicians handling the hardware. Consequently, there is a continuing drive to enhance the robustness of these connectorized assemblies, while preserving quick, reliable, and trouble-free optical connection to the network.

### SUMMARY

Fiber optic connectors, connectorized cable assemblies, closure assemblies, and methods for connecting fiber optic connectors to, and disconnecting fiber optic connectors from closure assemblies are disclosed herein.

In a first aspect A1, the present disclosure provides a fiber optic connector assembly comprising a connector housing defining a rotationally-discrete locking portion defined on an outer surface of the connector housing, an adapter assembly selectively coupled to the connector housing, the adapter assembly comprising a conversion housing extending around the connector housing and defining a conversion front end and a conversion retention member that is positionable between an engaged position, in which the conversion retention member restricts movement of the connector housing with respect to the adapter assembly in an axial direction, and a disengaged position, in which the connector housing is movable with respect to the adapter assembly in the axial direction, and a release housing positioned between the conversion housing and the connector housing, the release housing defining a release front end positionable at least partially within the conversion housing, and a release face selectively engageable with the conversion retention member and configured to move the conversion retention member from the engaged position to the disengaged position.

In a second aspect A2, the present disclosure provides the fiber optic connector assembly of aspect A1, further comprising a boot coupled to the release housing opposite the release front end.

In a third aspect A3, the present disclosure provides the fiber optic connector assembly of either of aspects A1 or A2, wherein the conversion retention member of the conversion housing defines forwardly-facing connector engagement face, and the rotationally-discrete locking portion of the connector housing defining a connector locking face.

In a fourth aspect A4, the present disclosure provides the fiber optic connector assembly of aspect A3, wherein the conversion retention member of the conversion housing defines a release face that is transverse to the forwardly-facing connector engagement face.

In a fifth aspect A5, the present disclosure provides the fiber optic connector assembly of aspect A4, wherein the release face faces inward in a radial direction that is transverse to the axial direction.

In a sixth aspect A6, the present disclosure provides the fiber optic connector assembly of any of aspects A1-A5, wherein the release housing defines one or more release faces that are selectively engageable with the conversion housing.

In a seventh aspect A7, the present disclosure provides the fiber optic connector assembly of aspect A6, wherein the one or more release faces face outwardly in a radial direction that is transverse to the axial direction.

In an eighth aspect A8, the present disclosure provides the fiber optic connector assembly of any of aspects A1-A7, wherein the conversion housing defines a conversion inner sidewall and a forward conversion ledge and a conversion inner space, and wherein the conversion retention member extends rearwardly from the forward conversion ledge into the conversion inner space.

In a ninth aspect A9, the present disclosure provides the fiber optic connector assembly of aspect A8, wherein the conversion retention member intersects the forward conversion ledge at a transition intersection, wherein at least a portion of the transition intersection is transverse to the forward conversion ledge and the conversion retention member.

In a tenth aspect A10, the present disclosure provides the fiber optic connector assembly of any of aspects A1-A9, wherein the release housing defines a release outer surface extending the axial direction, and a release slot extending through the release outer surface, and wherein the conversion retention member is positioned at least partially within the release slot in the engaged position.

In an eleventh aspect A11, the present disclosure provides the fiber optic connector assembly of aspect A10, wherein the release housing defines a release retainer extending over at least a portion of the release slot.

In a twelfth aspect A12, the present disclosure provides the fiber optic connector assembly of either of aspects A10 or A11, wherein the release housing defines a release face positioned adjacent to the release slot, wherein the release face faces outward in a radial direction that is transverse to the axial direction.

In a thirteenth aspect A13, the present disclosure provides the fiber optic connector assembly of aspect A12, wherein the release face of the release housing is a first release face, and wherein the release housing further comprises a second release face, wherein the first release face and the second release face are positioned on opposite sides of the release slot.

In a fourteenth aspect A14, the present disclosure provides the fiber optic connector assembly of any of aspects A1-A13, wherein the conversion front end defines a forward conversion keying feature structurally configured to engage an SC connector.

In a fifteenth aspect A15, the present disclosure provides the fiber optic connector assembly of any of aspects A1-A14, wherein the release housing defines an inward release keying portion and wherein the connector housing defines a connector keying portion that is engaged with the inward release keying portion.

In a sixteenth aspect A16, the present disclosure provides the fiber optic connector assembly of any of aspects A1-A15, wherein the release housing defines an outward release keying portion and wherein the conversion housing defines a rearward conversion keying feature engaged with the outward release keying portion.

In a seventeenth aspect A17, the present disclosure provides the fiber optic connector assembly of aspect A1, wherein the conversion retention member of the conversion housing defines forwardly-facing connector engagement face, the rotationally-discrete locking portion of the connector housing defining a connector locking face engaged with the forwardly-facing connector engagement face when the conversion retention member is in the engaged position, the conversion retention member of the conversion housing defines a release face that is transverse to the forwardly-facing connector engagement face, the release housing defines one or more release faces that are selectively engageable with the conversion housing, and the release face faces inward in a radial direction that is transverse to the axial direction.

In an eighteenth aspect A18, the present disclosure provides a fiber optic connector assembly comprising a connector housing defining a locking portion on an outer surface of the connector housing, and a connector keying portion on the outer surface of the connector housing, an adapter assembly selectively coupled to the connector housing, the adapter assembly comprising a conversion housing extending around the connector housing and defining a conversion front end and a conversion retention member selectively engaged with the locking portion of the connector housing, and a release housing positioned between the conversion housing and the connector housing, the release housing defining an inward release keying portion engaged with the connector keying portion, and a release face that is selectively engageable with the conversion retention member.

In a nineteenth aspect A19, the present disclosure provides the fiber optic connector assembly of aspect A18, wherein the conversion housing defines a forward conversion keying feature structurally configured to engage an SC connector.

In a twentieth aspect A20, the present disclosure provides the fiber optic connector assembly of aspect A19, wherein the conversion housing further defines a conversion guide extending outward from the conversion housing and aligned with the forward conversion keying feature.

In a twenty-first aspect A21, the present disclosure provides the fiber optic connector assembly of any of aspects A18-A20, wherein the release housing defines an outward release keying portion on a release outer surface of the release housing.

In a twenty-second aspect A22, the present disclosure provides the fiber optic connector assembly of aspect A21, wherein the conversion housing defines a rearward conversion keying feature engaged with the outward release keying portion.

In a twenty-third aspect A23, the present disclosure provides the fiber optic connector assembly of aspect A22, wherein the rearward conversion keying feature defines a slot engaged with the outward release keying portion of the release housing.

In a twenty-fourth aspect A24, the present disclosure provides the fiber optic connector assembly of any of aspects A21-A23, wherein the outward release keying portion is formed as a positive surface projection extending outward from the release outer surface and defines opposing outward release contact surfaces.

In a twenty-fifth aspect A25, the present disclosure provides the fiber optic connector assembly of any of aspects A18-A24, wherein the connector keying portion is formed as a negative cut out and defines opposing connector contact surfaces.

In a twenty-sixth aspect A26, the present disclosure provides the fiber optic connector assembly of any of aspects A18-A23, wherein the inward release keying portion is formed as a positive surface projection extending inward from a release inner surface in a radial direction that is transverse to an axial direction.

In a twenty-seventh aspect A27, the present disclosure provides the fiber optic connector assembly of aspect A18, wherein the conversion housing defines a forward conversion keying feature structurally configured to engage an SC connector, the release housing defines an outward release keying portion on a release outer surface of the release housing, and the conversion housing defines a rearward conversion keying feature engaged with the outward release keying portion.

In a twenty-eighth aspect A28, the present disclosure provides a method for disconnecting a fiber optic connector from a closure, the method comprising moving a release housing in an axial direction with respect to a conversion housing engaged with a connector housing, wherein the conversion housing comprises a conversion retention member engaged with a rotationally-discrete locking portion of the connector housing, engaging the conversion retention member of the conversion housing with a release face of the release housing, thereby moving the conversion retention member out of engagement with the rotationally-discrete locking portion of the connector housing, and removing the connector housing from the conversion housing.

In a twenty-ninth aspect A29, the present disclosure provides the method of aspect A28, wherein moving the release housing in the axial direction with respect to the conversion housing comprises moving a boot coupled to the release housing in the axial direction with respect to the conversion housing.

In a thirtieth aspect A30, the present disclosure provides the method of either of aspects A28 or A29, wherein moving the conversion retention member out of engagement with the rotationally-discrete locking portion of the connector housing comprises deflecting the conversion retention member in a radially-outward direction.

In a thirty-first aspect A31, the present disclosure provides the method of any of aspects A28-A30, wherein moving the conversion retention member out of engagement with the rotationally-discrete locking portion of the connector housing comprises moving a forwardly-facing connector engagement face out of the conversion retention member radially outward from a connector engagement face of rotationally-discrete locking portion of the connector housing.

Additional features of fiber optic connectors, connectorized cable assemblies, closure assemblies, and methods for connecting fiber optic connectors to, and disconnecting fiber optic connectors from closure assemblies will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts an isometric view of a closure and fiber optic connector assemblies inserted at least partially into the closure, according to one or more embodiments shown and described herein;

FIG. 2A schematically depicts an isometric view of a coupling and a fiber optic connector assembly including a connector housing and an adapter assembly including a conversion housing and a release housing, according to one or more embodiments shown and described herein;

FIG. 2B schematically depicts an exploded isometric view of the fiber optic connector assembly and the coupling of FIG. 2A, according to one or more embodiments shown and described herein;

FIG. 3A schematically depicts a front isometric view of the connector housing of FIG. 2A, according to one or more embodiments shown and described herein;

FIG. 3B schematically depicts an isometric view of the release housing of FIG. 2A, according to one or more embodiments shown and described herein;

FIG. 3C schematically depicts an isometric section view of the release housing of FIG. 3B, according to one or more embodiments shown and described herein;

FIG. 4 schematically depicts a side isometric view of the release housing of FIG. 2A, according to one or more embodiments shown and described herein;

FIG. 5 schematically depicts a section isometric view of the conversion housing of FIG. 2A, according to one or more embodiments shown and described herein;

FIG. 6 schematically depicts a rear section view of the conversion housing of FIG. 5, according to one or more embodiments shown and described herein;

FIG. 7A schematically depicts an isometric section view of the conversion housing of FIG. 5, according to one or more embodiments shown and described herein;

FIG. 7B schematically depicts a side section view of the conversion housing of FIG. 5, according to one or more embodiments shown and described herein;

FIG. 7C schematically depicts a side section view of another conversion housing, according to one or more embodiments shown and described herein;

FIG. 8 schematically depicts an exploded isometric view of the fiber optic connector assembly of FIG. 2A and a receptacle, according to one or more embodiments shown and described herein;

FIG. 9 schematically depicts a section view of the fiber optic connector assembly of FIG. 8 engaged with the receptacle of FIG. 8, according to one or more embodiments shown and described herein;

FIG. 10A schematically depicts a section view of the fiber optic connector assembly of FIG. 2A with the conversion housing in an engaged position, according to one or more embodiments shown and described herein;

FIG. 10B schematically depicts a section view of the fiber optic connector assembly of FIG. 2A with the conversion housing in a disengaged position, according to one or more embodiments shown and described herein;

FIG. 11 schematically depicts a side isometric view of another release housing, according to one or more embodiments shown and described herein; and

FIG. 12 schematically depicts a side view of a fiber optic connector assembly including the release housing of FIG. 11, according to one or more embodiments shown and described herein.

### DETAILED DESCRIPTION

Reference will now be made in detail to embodiments of optical adapter assemblies, examples of which are illustrated in the accompanying drawings. Whenever possible, the same reference numerals will be used throughout the drawings to refer to the same or like parts. Embodiments described herein are directed to fiber optic connector assemblies including a connector housing and an adapter assembly including a conversion housing and a release housing. The conversion housing may generally permit the connector housing to be engaged with a dissimilar coupling, for example of a closure. The connector housing may be selectively coupled to, and may be releasable from the conversion housing via the release housing, thereby allowing the connector housing to be selectively coupled to and released from the dissimilar coupling and/or closure.

As used herein, the term “longitudinal direction” refers to the forward-rearward direction of the components described herein (i.e., in the +/−z-direction as depicted). The term “lateral direction” refers to the cross-wise direction of the components (i.e., in the +/−x-direction as depicted), and is transverse to the longitudinal direction. The term “vertical direction” refers to the upward-downward direction of the components (i.e., in the +/−y-direction as depicted). The term “axial direction” generally refers to the longitudinal direction of fiber optic connector assemblies described herein. The term “radial direction” refers to the direction extending outward from the longitudinal direction of fiber optic connector assemblies described herein (i.e., in the R-direction as depicted). The term “circumferential direction refers to the direction extending around the longitudinal direction of fiber optic connector assemblies described herein (i.e., in the C-direction as depicted).

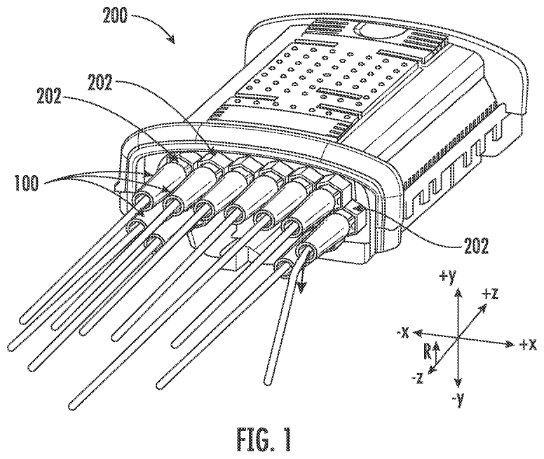

Referring initially to FIG. 1, a closure 200 is depicted with multiple fiber optic connector assemblies 100 inserted at least partially into the closure 200. In embodiments, the closure 200 may facilitate the connection of multiple fiber optic connector assemblies 100. In some embodiments, the closure 200 may be a boite de protection d'epissurages optiques (BPEO) closure, however, it should be understood that this is merely an example. As shown in FIG. 1, closures 200 may include multiple closure openings 202 that can each receive a fiber optic connector assembly 100. In embodiments, the closure openings 202 may be positioned adjacent to one another in the vertical direction and/or in the lateral direction (i.e., in the +/−y-direction and the +/−x-direction as depicted). In other words, the closure openings 202 may be positioned on top of one another in the vertical direction, and may be placed side-by-side to one another in the lateral direction (i.e., in the +/−y-direction and the +/−x-direction as depicted, respectively). By positioning the closure openings 202 adjacent to one another in the vertical direction and the lateral direction (i.e., in the +/−y-direction and the +/−x-direction as depicted), multiple fiber optic connector assemblies 100 may be inserted into the closure 200 even when the closure 200 has a comparatively small footprint evaluated in the vertical and lateral directions. In other words, by positioning the closure openings 202 adjacent to one another in the vertical direction and the lateral direction, the number of fiber optic connector assemblies 100 inserted into the closure 200 may be increased as compared to similarly-sized closures having closure openings that are not positioned adjacent to one another in the vertical direction and the lateral direction.

However, with fiber optic connector assemblies 100 positioned adjacent to one another in the vertical direction and the lateral direction (i.e., in the +/−y-direction and the +/−x-direction as depicted), it may be difficult for users to insert and remove the fiber optic connector assemblies 100 from the closure 200. In particular, space between adjacent fiber optic connector assemblies 100 in the vertical direction and the lateral direction (i.e., in the +/−y-direction and the +/−x-direction as depicted, respectively) may be minimal. Minimal distance between the fiber optic connector assemblies 100 may make it difficult for a user to manipulate any of the fiber optic connector assemblies 100 to remove or insert the fiber optic connector assemblies 100 to the closure 200.

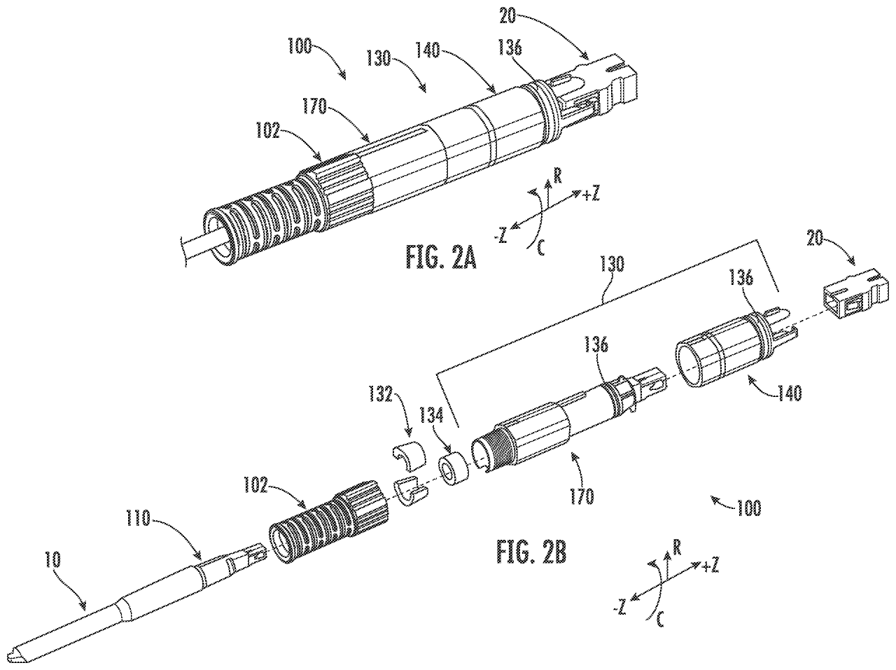

Referring to FIGS. 2A and 2B, an isometric view and an exploded isometric view of a fiber optic connector assembly 100 of a fiber optic cable 10 are schematically depicted, respectively. In embodiments, the fiber optic connector assembly 100 includes a connector housing 110 and an adapter assembly 130 including a conversion housing 140 and a release housing 170. The conversion housing 140 is engageable with a coupling 20. In the embodiment depicted in FIGS. 2A and 2B, the coupling is embodied as an SC coupling, however, it should be understood that this is merely an example, and the conversion housing 140 may be engageable with any suitable coupling, for example and without limitation, an LC coupling or the like. In some embodiments, couplings 20 may be positioned at least partially within the closure openings 202 (FIG. 1), and the fiber optic connector assemblies 100 inserted into the closure 200 (FIG. 1) may each interface with a coupling 20.

In some embodiments, the fiber optic connector assembly 100 further includes a boot 102 coupled to the release housing 170. The boot 102 and the release housing 170 may be selectively movable with respect to the conversion housing 140 in the longitudinal direction (i.e., in the +/−z-direction as depicted), as described in greater detail herein.

In some embodiments, the fiber optic connector assembly 100 may include a grommet 132 and/or a washer 134. The connector housing 110 may be passed through the grommet 132 and/or the washer 134, and the grommet 132 and/or the washer 134 may restrict environmental elements (e.g., water, humidity, etc.) from reaching an interior of the fiber optic connector assembly 100. While in the embodiment depicted in FIG. 2B the grommet 132 is depicted as having a two-piece construction, it should be understood that this is merely an example. In some embodiments, the fiber optic connector assembly 100 may include one or more sealing elements 136 engaged with the release housing 170 and/or the conversion housing 140. The one or more sealing elements 136 may include o-rings or the like.

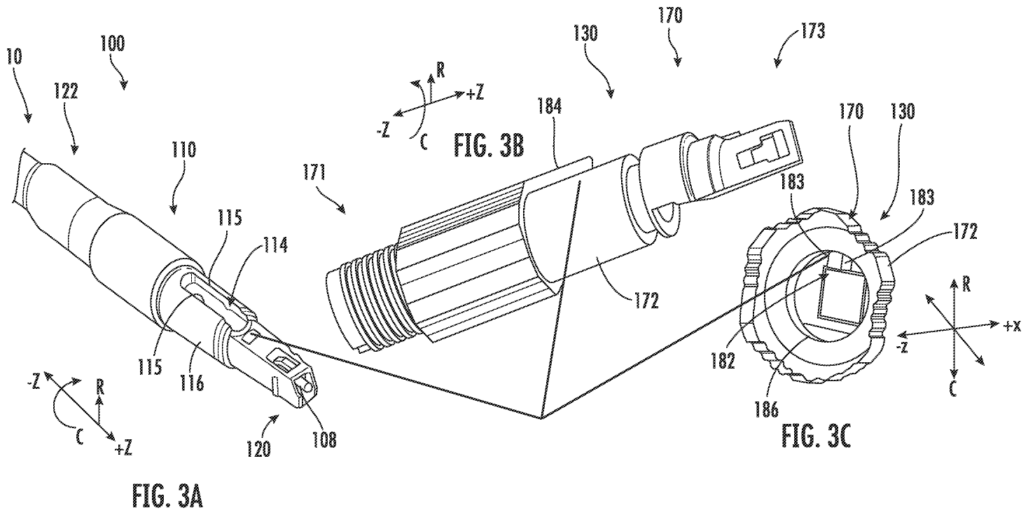

Referring to FIGS. 3A and 3B, a front isometric view of the connector housing 110 of the fiber optic cable 10 and an isometric view of the release housing 170 are schematically depicted, respectively. In embodiments, the connector housing 110 defines an outer surface 116 extending from a rear end 122 to a front end 120 in the longitudinal direction (i.e., in the +/−z-direction as depicted). In embodiments, a ferrule 108 may be positioned at the front end 120 of the connector housing 110. An optical fiber may extend through the ferrule 108 in the longitudinal direction (i.e., in the +/−z-direction as depicted). In embodiments in which the fiber optic cable 10 includes a single optical fiber, the optical fiber may be coaxial with the longitudinal direction (i.e., the +/−z-direction as depicted). For multifiber cables, this alignment will be offset for one, more than one, or all of the optical fibers of the fiber optic cable 10.

The connector housing 110 includes a connector keying portion 114 defined on the outer surface 116 of the connector housing 110. In embodiments, the connector keying portion 114 may be rotationally discrete on the outer surface 116 of the connector housing 110. As used herein, the term “rotationally” discrete represents a limited width-wise extent along the outer surface 116 of the connector housing 110, as the connector housing 110 is rotated in the circumferential direction C.

In embodiments, the connector keying portion 114 includes pair of opposing connector contact surfaces 115. The opposing connector contact surfaces 115 are structurally configured to inhibit rotation of the connector housing 110 in the circumferential direction C when engaged with a complementary keying portion of, for example, an optical connection port. However, some optical connection ports, such as those of the closure 200 (FIG. 1) and the coupling 20 (FIG. 2B) may not be sized and/or shaped to directly interface with the connector housing 110. In these configurations, the opposing connector contact surfaces 115 of the connector keying portion 114 may interface with a keying portion of the adapter assembly 130, and the adapter assembly 130 may interface with a keying portion of the closure 200 (FIG. 1) and/or the coupling 20 (FIG. 2B).

For example, and referring to FIGS. 3B and 3C, a section view of the release housing 170 is schematically depicted. In embodiments, the release housing 170 defines a release outer surface 172 extending from a release rear end 171 to a release front end 173 in the longitudinal direction (i.e., in the +/−z-direction as depicted). In embodiments, the release housing 170 defines a release inner surface 186 opposite the release outer surface 172. In the embodiment depicted in FIG. 3C, the release housing 170 defines an inward release keying portion 182. For example, in the embodiment depicted in FIG. 3C, the inward release keying portion 182 defines a pair of opposing contact surfaces 183 extending inward from the release inner surface 186 in the radial direction R.

When assembled, the connector housing 110 may be at least partially inserted into the release housing 170. In embodiments, the connector keying portion 114 of the connector housing 110 is engageable with the inward release keying portion 182 of the release housing 170. For example, in the embodiment depicted in FIGS. 3A and 3C, the connector keying portion 114 is formed as a negative cutout extending into the connector housing 110, and the inward release keying portion 182 is formed as a positive surface projection extending from the release inner surface 186 in the radial direction R. In embodiments, the opposing connector contact surfaces 115 of the connector keying portion 114 of the connector housing 110 may engage the opposing contact surfaces 183 of the inward release keying portion 182 of the release housing 170, thereby restricting rotation of the connector housing 110 with respect to the release housing 170. Furthermore, the inward release keying portion 182 of the release housing 170 may assist in ensuring rotational alignment between the connector housing 110 and the release housing 170. For example, in the embodiment depicted in FIGS. 3A and 3C, the inward release keying portion 182 may interfere with portions of outer surface 116 of the connector housing 110 other than the connector keying portion 114. Interference between the inward release keying portion 182 with the outer surface 116 of the connector housing 110 may restrict insertion of the connector housing 110 into the release housing 170 unless the connector keying portion 114 of the connector housing 110 is aligned with the inward release keying portion 182 of the release housing 170 in the circumferential direction C. In embodiments, the ferrule 108, and the optic fiber or fibers extending through the ferrule 108, may be positioned at a particular rotational orientation with respect to the connector housing 110. By allowing the connector housing 110 (and accordingly the ferrule 108) to be fully inserted into the release housing 170 in only one rotational orientation, the optical fiber or fibers extending through the ferrule 108 may be rotationally aligned with a corresponding optical fiber or fibers of a closure 200 (FIG. 1), as described in greater detail herein.

While in the embodiment depicted in FIGS. 3A and 3C, the connector keying portion 114 of the connector housing 110 is described and depicted as a negative cutout and the inward release keying portion 182 of the release housing 170 is described and depicted as being a positive surface projection, it should be understood that this is merely an example. In embodiments, the connector keying portion 114 of the connector housing 110 and the inward release keying portion 182 of the release housing 170 may include any suitable complementary shapes to restrict rotation between the release housing 170 and the connector housing 110 and to ensure rotational alignment between the release housing 170 and the connector housing 110. For example, in embodiments, the connector keying portion 114 may be a positive surface projection extending outward from the outer surface 116 of the connector housing 110, and the inward release keying portion 182 may be a negative cutout extending into the release inner surface 186 of the release housing 170.

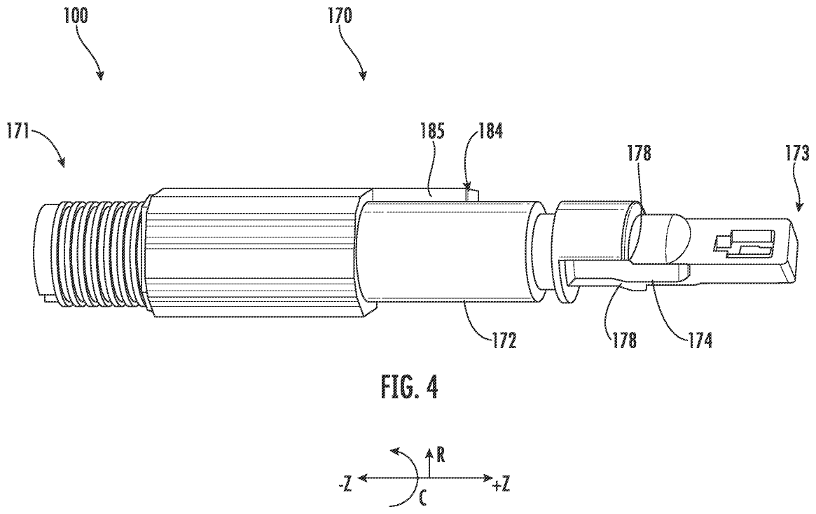

Referring to FIG. 4 a side isometric view of the release housing 170 is schematically depicted. In embodiments, the release housing 170 defines a release slot 174 extending through the release outer surface 172. The release housing 170 may further define one or more release faces 178 that are selectively engageable with the conversion housing 140 (FIG. 2B), as described in greater detail herein. In the embodiment depicted in FIG. 4, the release housing 170 defines a pair of release faces 178 positioned opposite one another across the release slot 174, however, it should be understood that this is merely an example, and the release housing 170 may define a single release face or any suitable number of release faces. In embodiments, the release faces 178 face outwardly in the radial direction R and rearwardly in the longitudinal direction (i.e., in the −z-direction as depicted).

In embodiments, the release housing 170 defines an outward release keying portion 184 positioned on the release outer surface 172. The outward release keying portion 184 generally includes outward release contact surfaces 185 that are positioned opposite one another. For example, in the embodiment depicted in FIG. 4, the outward release keying portion 184 is formed as a positive surface projection extending outward form the release outer surface 172 in the radial direction R, and the outward release contact surfaces 185 face in opposite directions. The outward release contact surfaces 185 may engage a corresponding keying portion of the conversion housing 140 (FIG. 2B), as described in greater detail herein.

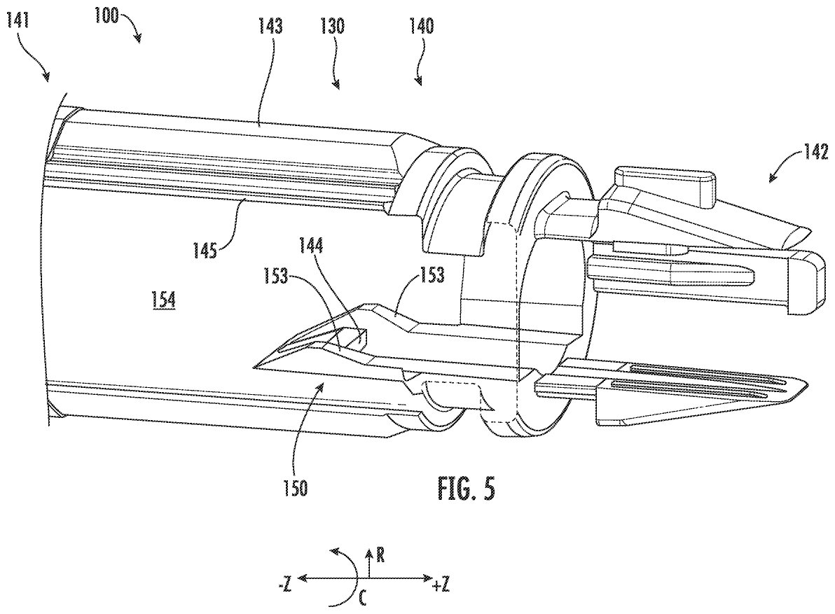

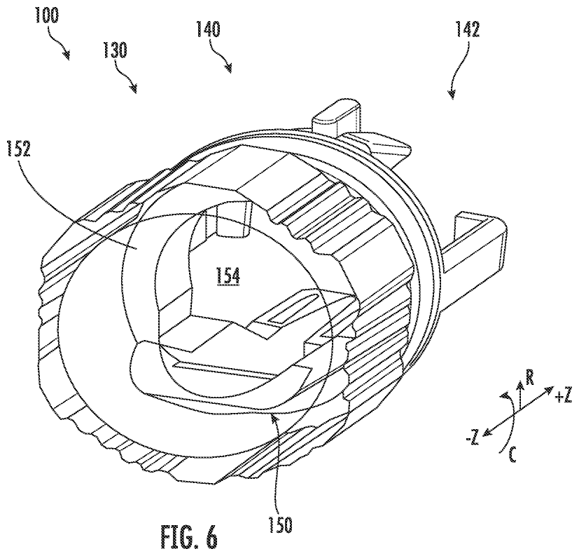

Referring to FIGS. 5 and 6, a side section view and a rear section view of the conversion housing 140 are schematically depicted, respectively. In embodiments, the conversion housing 140 extends between a conversion rear end 141 and a conversion front end 142 in the longitudinal direction (i.e., in the +/−z-direction as depicted). The conversion housing 140 generally defines a conversion outer surface 143 and a conversion inner sidewall 145 opposite the conversion outer surface 143. The conversion housing 140 further defines a conversion inner space 154 that may receive the release housing 170 (FIG. 4), as described in greater detail herein.

In embodiments, the conversion housing 140 includes a conversion retention member 150. The conversion retention member 150 generally defines a forwardly-facing connector engagement face 144 that is structurally configured to engage an engagement face of the connector housing 110 (FIG. 2B), as described in greater detail herein. In embodiments, the forwardly-facing connector engagement face 144 faces forward in the longitudinal direction (i.e., in the +z-direction as depicted). In some embodiments, the forwardly-facing connector engagement face 144 is orthogonal to the longitudinal direction (i.e., the +/−z-direction as depicted). In some embodiments, the forwardly-facing connector engagement face 144 may not be orthogonal to the longitudinal direction (i.e., the +/−z-direction as depicted), and may face at least partially outwardly or inwardly in the radial direction R. As described in greater detail herein, the orientation of the forwardly-facing connector engagement face 144 with respect to the longitudinal direction (i.e., the +/−z-direction as depicted) may restrict the withdrawal of the connector housing 110 (FIG. 2B) from the conversion housing 140.

In some embodiments, the conversion retention member 150 defines a rearwardly-facing ramp 151 opposite the forwardly-facing connector engagement face 144. The rearwardly-facing ramp 151 may face rearward in the longitudinal direction (i.e., in the −z-direction as depicted) and may face at least partially inward in the radial direction R. When the connector housing 110 (FIG. 3A) and/or the release housing 170 (FIG. 4) are inserted into the conversion housing 140, the connector housing 110 and/or the release housing 170 may engage the rearwardly-facing ramp 151 of the conversion retention member 150. Because the rearwardly-facing ramp 151 faces at least partially inward in the radial direction R, as the connector housing 110 (FIG. 3A) and/or the release housing 170 (FIG. 4) are inserted into the conversion housing 140 in the longitudinal direction (i.e., in the +z-direction as depicted), the conversion retention member 150 may deflect outwardly in the radial direction R.

In some embodiments, the conversion retention member 150 defines a forwardly-facing conversion release face 153. In the embodiment depicted in FIG. 5, the conversion retention member 150 defines a pair of forwardly-facing conversion release faces 153 that are positioned on opposite sides of the forwardly-facing connector engagement face 144. In embodiments, the forwardly-facing conversion release faces 153 may face forward in the longitudinal direction (i.e., in the +z-direction as depicted) and inward in the radial direction R. The forwardly-facing conversion release faces 153 may engage the release faces 178 (FIG. 4) of the release housing 170 (FIG. 4), as described in greater detail herein.

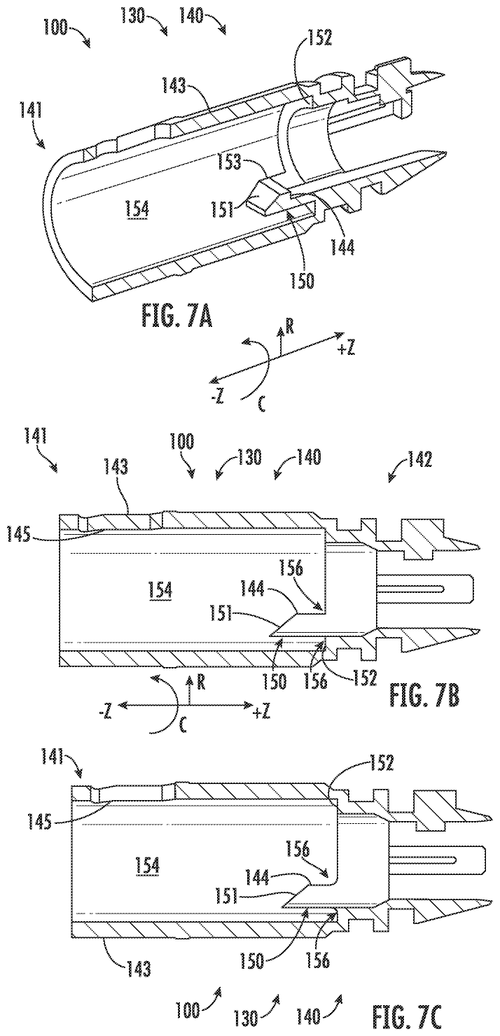

Referring to FIGS. 7A and 7B, an isometric section view and a side section view of the conversion housing 140 is schematically depicted. In embodiments, the conversion inner space 154 is defined at least in part by the conversion inner sidewall 145 and a forward conversion ledge 152. The forward conversion ledge 152 is positioned at the conversion front end 142 and may generally extend inwardly in the radial direction from the conversion inner sidewall 145 in the radial direction R. In some embodiments, the forward conversion ledge 152 may be oriented transverse to the longitudinal direction (i.e., the +/−z-direction as depicted) and may limit the insertion of the release housing 170 (FIG. 4) and/or the connector housing 110 (FIG. 2B) into the conversion inner space 154.

As shown in FIGS. 7A and 7B, in some embodiments, the conversion retention member 150 extends rearwardly from the forward conversion ledge 152 into the conversion inner space 154. For example, in the embodiment depicted in FIGS. 7A and 7B, the conversion retention member 150 is a cantilever extending rearwardly from the forward conversion ledge 152, however, it should be understood that this is merely an example.

In embodiments, the conversion retention member 150 intersects at the forward conversion ledge 152 at a transition intersection 156. Without being bound by theory, the shape and structure of the transition intersection 156 impacts the movement of the conversion retention member 150 in the radial direction R, for example, under the application of force. While in the embodiment depicted in FIG. 7B the forward conversion ledge 152 and the conversion retention member 150 form a generally perpendicular transition intersection 156, it should be understood that this is merely an example.

For example, and referring to FIG. 7C, in some embodiments, at least a portion of the transition intersection 156 is transverse to the forward conversion ledge 152 and the conversion retention member 150. In particular, in the embodiment depicted in FIG. 7C, the transition intersection 156 defines a fillet between the forward conversion ledge 152 and the conversion retention member 150. By defining a fillet between the forward conversion ledge 152 and the conversion retention member 150, stress concentration at the transition intersection 156 may be reduced. Further, by defining a fillet between the forward conversion ledge 152 and the conversion retention member 150, the conversion retention member 150 may resist deflection in the radial direction R. As noted above, the conversion retention member 150 may deflect outwardly in the radial direction, for example, upon insertion of the connector housing 110 (FIG. 3) and/or release housing 170 (FIG. 4) into the conversion housing 140. However, the conversion retention member 150 may generally retain the connector housing 110 (FIG. 3A) within the conversion housing 140, and outward deflection of the conversion retention member 150 may inadvertently release the connector housing 110 from the conversion housing 140. Accordingly, the shape of the transition intersection 156 may be selected to permit deflection of the conversion retention member 150 in the radial direction R to allow insertion of the connector housing 110 (FIG. 3A) and the release housing 170 (FIG. 4) into the conversion housing 140. However, the shape of the transition intersection 156 may also be selected to resist deflection of the conversion retention member 150 in the radial direction R to restrict inadvertent release of the connector housing 110, as described in greater detail herein. In embodiments, a thickness of the conversion retention member 150 evaluated in the radial direction R may also be selected such that the conversion retention member 150 deflects in the radial direction R to allow insertion of the connector housing 110 (FIG. 3A) and the release housing 170 (FIG. 4) into the conversion housing 140. However, the thickness of the conversion retention member 150 may also be selected to resist deflection of the conversion retention member 150 in the radial direction R to restrict inadvertent release of the connector housing 110.

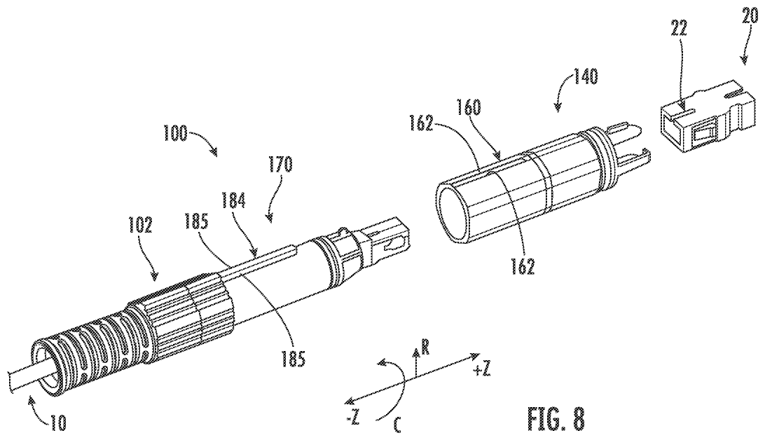

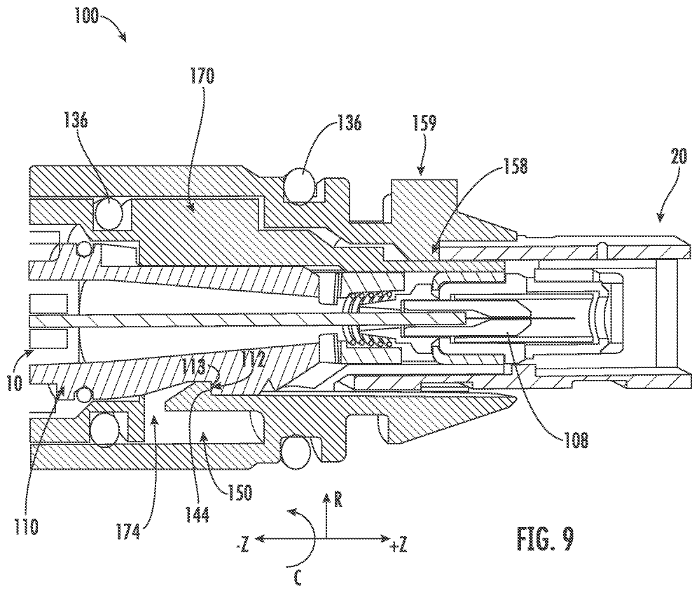

Referring to FIGS. 8 and 9, an exploded view of the fiber optic connector assembly 100 and a section view of the fiber optic connector assembly 100 are depicted, respectively. When assembled, the connector housing 110 is inserted at least partially into the release housing 170, as shown in FIG. 8. The release housing 170 and the connector housing 110 are inserted at least partially into the conversion housing 140.

As shown in FIG. 8, in embodiments, the conversion housing 140 may include a rearward conversion keying feature 160 that is configured to engage the outward release keying portion 184. For example, in the embodiment depicted in FIG. 8, the rearward conversion keying feature 160 defines opposing contact surfaces 162 that are configured to engage the contact surfaces 185 of the outward release keying portion 184 of the release housing 170. In the embodiment depicted in FIG. 8, the rearward conversion keying feature 160 is depicted as being a slot that receives the outward release keying portion 184, however, it should be understood that this is merely an example. In embodiments, the rearward conversion keying feature 160 may include any suitable keying feature for interfacing with the outward release keying portion 184 of the release housing 170.

Referring to FIG. 9, the connector housing 110 is generally inserted at least partially into the release housing 170, and the release housing 170 and the connector housing 110 are at least partially inserted into the conversion housing 140.

As noted above, the connector housing 110 may be rotationally aligned with respect to the release housing 170 via the connector keying portion 114 (FIG. 3A) of the connector housing 110 and the inward release keying portion 182 (FIG. 3B) of the release housing 170. The release housing 170 is rotationally aligned with the conversion housing 140 via the outward release keying portion 184 (FIG. 3B) of the release housing 170 and the rearward conversion keying feature 160 (FIG. 8) of the conversion housing 140 (FIG. 8). In this way, the connector housing 110 is rotationally aligned with the release housing 170, which is in turn rotationally aligned with the conversion housing 140, such that the connector housing 110 is rotationally aligned with the conversion housing 140.

In some embodiments, the conversion housing 140 defines a forward conversion keying feature 158. The forward conversion keying feature 158 may cooperate with a slot 22 (FIG. 8) of the coupling 20 as the conversion housing 140 is inserted into the coupling 20. For example, the conversion housing 140 may be restricted from being inserted into the coupling 20 unless the forward conversion keying feature 158 is rotationally aligned with the slot 22 (FIG. 8) of the coupling 20. By rotationally aligning the conversion housing 140 with the coupling 20, the connector housing 110 may be rotationally aligned with the coupling 20 (e.g., through the conversion housing 140 and the release housing 170). By rotationally aligning the connector housing 110 with the coupling 20, the ferrule 108 may be rotationally aligned with the coupling 20 such that the optical fiber or optical fibers extending through the ferrule 108 may be optically coupled to an optical fiber or optical fibers of an opposing ferrule positioned within the coupling 20. In some embodiments, the conversion housing 140 may define a conversion guide 159 extending outward from the conversion housing 140, where the conversion guide 159 is aligned with the forward conversion keying feature 158. The conversion guide 159 may assist in providing a visual indication of the rotational position of the forward conversion keying feature 158 such that a user, such as a technician, may orient the forward conversion keying feature 158 with the slot 22 (FIG. 8) of the coupling 20.

In embodiments, the connector housing 110 defines a rotationally-discrete locking portion 112 on the outer surface 116 of the connector housing 110. In some embodiments, the rotationally-discrete locking portion 112 defines a connector locking face 113 that, in the embodiment depicted in FIG. 8 faces rearwardly in the longitudinal direction (i.e., in the −z-direction as depicted). In embodiments, the conversion retention member 150 is positionable in an engaged position as shown in FIG. 9. In the engaged position, the conversion retention member 150 restricts movement of the connector housing 110 with respect to the adapter assembly 130, and more particularly the conversion housing 140, in the longitudinal direction (e.g., in the +/−z-direction as depicted). For example, in the engaged position, the conversion retention member 150 may restrict movement of the connector housing 110 with respect to the conversion housing 140 in the −z-direction as depicted, thereby restricting withdrawal of the connector housing 110 from the conversion housing 140. In particular and as shown in FIG. 9, the forwardly-facing connector engagement face 144 of the conversion retention member 150 may engage the connector locking face 113 of the connector housing 110, thereby restricting movement of the connector housing 110 in the −z-direction as depicted. In embodiments, the conversion retention member 150 may be positioned at least partially within the release slot 174 (FIG. 4) of the release housing such that the forwardly-facing connector engagement face 144 of the conversion retention member 150 may access the connector housing 110.

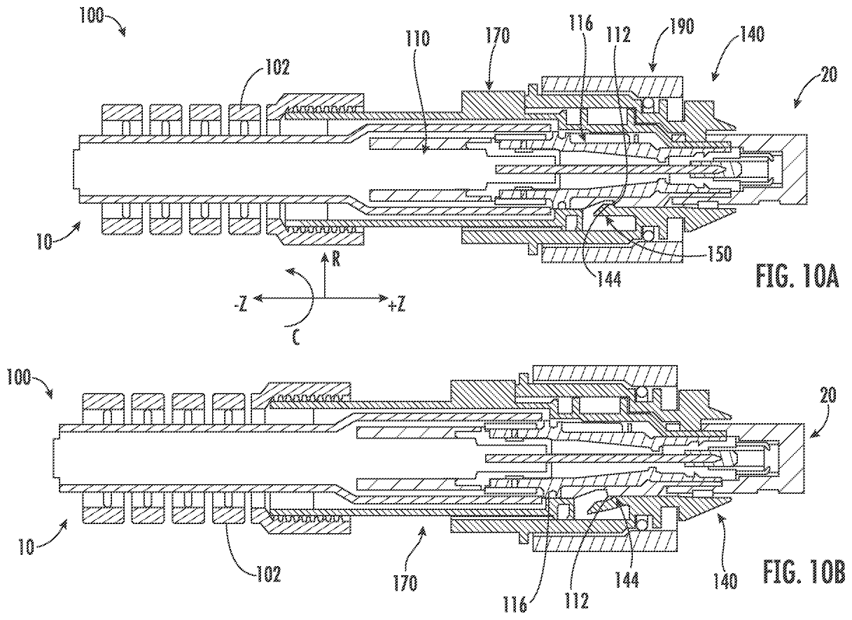

Referring to FIGS. 10A and 10B, a section view of the fiber optic connector assembly 100 is depicted with the conversion retention member 150 in the engaged position and in a disengaged position. As shown in FIG. 10B, in the disengaged position, the connector housing 110 is movable with respect to the adapter assembly 130, and more particularly the conversion housing 140, in the longitudinal direction (i.e., in the −z-direction as depicted).

More particularly and referring to FIGS. 4, 5, and 10B the conversion retention member 150 may be moved into the disengaged position by the release housing 170. For example, in embodiments, the release housing 170 may be moved rearward in the longitudinal direction (i.e., in the −z-direction as depicted). As the release housing 170 moves rearward in the longitudinal direction (i.e., in the −z-direction as depicted), the release faces 178 of the release housing 170 may engage the forwardly-facing conversion release faces 153 of the conversion retention member 150. In embodiments, the release housing 170 may be moved rearward in the longitudinal direction (i.e., in the −z-direction as depicted) by a user, such as a technician. In some embodiments, the boot 102 is coupled to the release housing 170, and the release housing 170 can be moved rearward in the longitudinal direction (i.e., in the −z-direction as depicted) by moving the boot 102 rearward in the longitudinal direction.

As the release faces 178 of the release housing 170 engage the forwardly-facing conversion release faces 153 of the conversion retention member 150, the release faces 178 move the conversion retention member 150 outward in the radial direction R. For example, and as noted above, in some embodiments, the conversion release faces 153 of the conversion retention member 150 may be face inward in the radial direction R. Accordingly, as the release housing 170 moves rearward in the longitudinal direction (i.e., in the −z-direction as depicted), the rearward movement of the release housing 170 may resolve into an outwardly radial force acting on the conversion retention member 150. Similarly, in embodiments in which the release faces 178 face outwardly in the radial direction R, as the release housing 170 moves rearward in the longitudinal direction (i.e., in the −z-direction as depicted), the rearward movement of the release housing 170 may resolve into an outwardly radial force acting on the conversion retention member 150.

As the conversion retention member 150 moves outward in the radial direction R the forwardly-facing connector engagement face 144 from the conversion retention member 150 disengages the rotationally-discrete locking portion 112 of the connector housing 110. With forwardly-facing connector engagement face 144 of the conversion retention member 150 disengaged from the rotationally-discrete locking portion 112 of the connector housing 110, the connector housing 110 can be removed from the conversion housing 140.

As such, the connector housing 110 can be disengaged from the conversion housing 140, and accordingly the coupling 20, through movement of the release housing 170 in the longitudinal direction (i.e., in the −z-direction as depicted). In this way, the connector housing 110 can be removed from the coupling 20 even when there is minimal distance between the connector housing 110 and other connector housings in the radial direction R. More particularly, while the conversion retention member 150 moves outward in the radial direction R to move from the engaged position to the disengaged position, this movement is generally within the conversion inner space 154. As such, the connector housing 110 can be disengaged from the conversion housing 140, and accordingly from the coupling 20, without requiring movement of components external to the conversion housing 140 in the radial direction R. Because the connector housing 110 can be disengaged from the conversion housing 140, and accordingly the coupling 20, without requiring movement of components external to the conversion housing 140 in the radial direction R, couplings 20 can be positioned adjacent to one another so as to minimize the distance between adjacent connector housings 110. In this way, closures 200 (FIG. 1) may include couplings 20 that are positioned adjacent to one another so as to minimize the distance between adjacent connector housings 110.

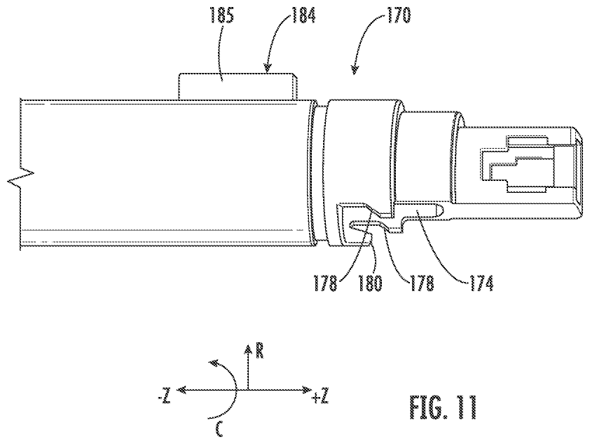

Referring to FIG. 11, an isometric view of another release housing 170 is schematically depicted. Like the embodiment described above and depicted in FIG. 4, the release housing 170 includes the release slot 174 and the one or more release faces 178. However, in the embodiment depicted in FIG. 11, the release housing 170 further includes a release retainer 180. As shown in FIG. 11, the release retainer 180 extends over at least a portion of the release slot 174.

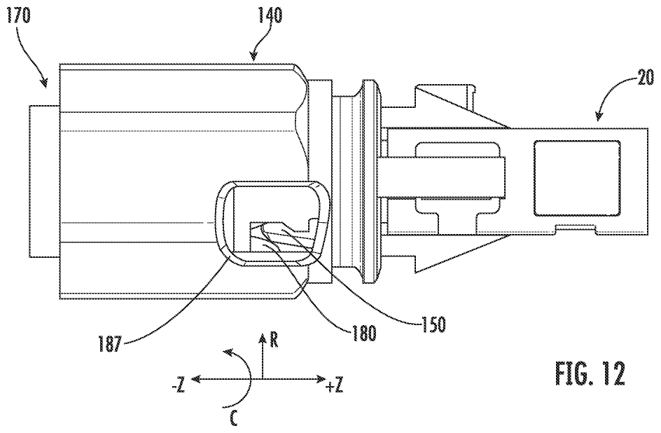

Referring to FIG. 12, in embodiments, a side view of the release housing 170 and the conversion housing 140 is depicted. The conversion housing 140 includes a window 187 through which the release retainer 180 of the release housing 170 can be viewed, however, it should be understood that this merely an example, and conversion housings 140 according to the present disclosure may not have the window 187.

As shown in FIG. 12, in embodiments, the release retainer 180 may engage the conversion retention member 150 of the conversion housing 140 and may restrict movement of the conversion retention member 150 outward in the radial direction R when the release housing 170 is fully inserted into the conversion housing 140. However, when the conversion housing 140 is moved rearward in the longitudinal direction (i.e., in the −z-direction as depicted), the release retainer 180 may disengage the conversion retention member 150, thereby allowing the conversion retention member 150 to move to the disengaged position as shown in FIG. 10B. Accordingly, the release retainer 180, in embodiments, may restrict inadvertent movement of the conversion retention member 150 while the release housing 170 is fully inserted into the conversion housing 140, while allowing the conversion retention member 150 to move to the disengaged position as the conversion housing 140 is moved rearward in the longitudinal direction (i.e., in the −z-direction as depicted).

Accordingly, embodiments described herein are generally directed to fiber optic connector assemblies including a connector housing and an adapter assembly including a conversion housing and a release housing. The conversion housing may generally permit the connector housing to be engaged with a dissimilar coupling, for example of a closure. The connector housing may be selectively coupled to, and may be releasable from the conversion housing via the release housing, thereby allowing the connector housing to be selectively coupled to and released from the dissimilar coupling and/or closure.

It is noted that recitations herein of a component of the present disclosure being “structurally configured” in a particular way, to embody a particular property, or to function in a particular manner, are structural recitations, as opposed to recitations of intended use. More specifically, the references herein to the manner in which a component is “structurally configured” denotes an existing physical condition of the component and, as such, is to be taken as a definite recitation of the structural characteristics of the component.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A fiber optic connector assembly comprising:
a connector housing defining:
a locking portion on an outer surface of the connector housing; and
a connector keying portion on the outer surface of the connector housing;
an adapter assembly selectively coupled to the connector housing, the adapter assembly comprising:
a conversion housing extending around the connector housing and defining a conversion front end and a conversion retention member selectively engaged with the locking portion of the connector housing; and
a release housing positioned between the conversion housing and the connector housing, the release housing defining:
an inward release keying portion engaged with the connector keying portion; and
a release face that is selectively engageable with the conversion retention member.

2. The fiber optic connector assembly of claim 1, wherein the conversion housing defines a forward conversion keying feature structurally configured to engage an SC connector.

3. The fiber optic connector assembly of claim 2, wherein the conversion housing further defines a conversion guide extending outward from the conversion housing and aligned with the forward conversion keying feature.

4. The fiber optic connector assembly of claim 1, wherein the release housing defines an outward release keying portion on a release outer surface of the release housing.

5. The fiber optic connector assembly of claim 4, wherein the conversion housing defines a rearward conversion keying feature engaged with the outward release keying portion.

6. The fiber optic connector assembly of claim 5, wherein the rearward conversion keying feature defines a slot engaged with the outward release keying portion of the release housing.

7. The fiber optic connector assembly of claim 4, wherein the outward release keying portion is formed as a positive surface projection extending outward from the release outer surface and defines opposing outward release contact surfaces.

8. The fiber optic connector assembly of claim 1, wherein the connector keying portion is formed as a negative cut out and defines opposing connector contact surfaces.

9. The fiber optic connector assembly of claim 1, wherein the inward release keying portion is formed as a positive surface projection extending inward from a release inner surface in a radial direction that is transverse to an axial direction.

10. The fiber optic connector assembly of claim 1, wherein the release housing defines a release outer surface extending the axial direction, and a release slot extending through the release outer surface, and wherein the conversion retention member is positioned at least partially within the release slot in the engaged position.

11. The fiber optic connector assembly of claim 10, wherein the release housing defines a release retainer extending over at least a portion of the release slot.

12. The fiber optic connector assembly of claim 10, wherein the release housing defines a release face positioned adjacent to the release slot, wherein the release face faces outward in a radial direction that is transverse to the axial direction.

13. The fiber optic connector assembly of claim 12, wherein the release face of the release housing is a first release face, and wherein the release housing further comprises a second release face, wherein the first release face and the second release face are positioned on opposite sides of the release slot.

14. The fiber optic connector assembly of claim 1, wherein the conversion front end defines a forward conversion keying feature structurally configured to engage an SC connector.

15. The fiber optic connector assembly of claim 1, wherein the release housing defines an inward release keying portion and wherein the connector housing defines a connector keying portion that is engaged with the inward release keying portion.

16. The fiber optic connector assembly of claim 1, wherein:
the conversion housing defines a forward conversion keying feature structurally configured to engage an SC connector;
the release housing defines an outward release keying portion on a release outer surface of the release housing; and
the conversion housing defines a rearward conversion keying feature engaged with the outward release keying portion.

17. A method for disconnecting a fiber optic connector from a closure, the method comprising:
moving a release housing in an axial direction with respect to a conversion housing engaged with a connector housing, wherein the conversion housing comprises a conversion retention member engaged with a rotationally-discrete locking portion of the connector housing;
engaging the conversion retention member of the conversion housing with a release face of the release housing, thereby moving the conversion retention member out of engagement with the rotationally-discrete locking portion of the connector housing; and
removing the connector housing from the conversion housing.

18. The method of claim 17, wherein moving the release housing in the axial direction with respect to the conversion housing comprises moving a boot coupled to the release housing in the axial direction with respect to the conversion housing.

19. The method of claim 17, wherein moving the conversion retention member out of engagement with the rotationally-discrete locking portion of the connector housing comprises deflecting the conversion retention member in a radially-outward direction.

20. The method of any of claim 17, wherein moving the conversion retention member out of engagement with the rotationally-discrete locking portion of the connector housing comprises moving a forwardly-facing connector engagement face out of the conversion retention member radially outward from a connector engagement face of rotationally-discrete locking portion of the connector housing.
